(19) United States
(12) Patent Application Publication
(10) Pub. No.: US 2018/0293790 A1
(43) Pub. Date: Oct. 11, 2018

(54) Method and Apparatus for Measuring 3Dimensional Structures

(71) Applicant: Michael John Darwin, Portland, OR (US)

(72) Inventor: Michael John Darwin, Portland, OR (US)

(21) Appl. No.: 15/925,121

(22) Filed: Mar. 19, 2018

Related U.S. Application Data
(60) Provisional application No. 62/474,114, filed on Mar. 21, 2017.

(51) Int. Cl. G06T 17/05; G06K 9/00; G06T 7/586

(52) U.S. Cl. CPC G06T 17/05; G06K 2209/40; G06T 7/586; G06K 9/00201

(57) ABSTRACT

A method and apparatus for the generation of 3Dimensional data for an object consisting of one or more light projection systems, a means of generating a light pattern or structure, one or more sensors for observing the reflected light, one or more sensors for registering position, one or more calibration methods for rationalizing the data, and one or more algorithms for automatically analyzing the data to reproduce the 3D structure.

### CROSS REFERENCE TO RELATED APPLICATION

This application claims the benefit of U.S. Provisional Application No. 62/474,114 filed on Mar. 21, 2017, entitled “Method and Apparatus for Measuring 3Dimensional Structures.”

### BACKGROUND OF INVENTION

### Field of Invention

The present invention relates to the non-contact methods and apparatus used for measuring the geometry of manufactured products. Several industries rely on geometrical measurements to insure quality control and sound manufacturing practices of a product, and in some cases, these geometrical measurements are integrated into the process flow to insure unit level specifications are met for pre-assemblies or integration.

In the case of Semiconductor Backend of Line processing, some manufactures deposit/grow copper pillars or bumps on the integrated circuit as one of the last processing steps in the factory. Control of the Bump Height and Bump Diameter are considered critical process parameters to control due to the impact on yield and electrical properties if they are not processed correctly. As such, fully automated systems have been created to inspect and measure, each silicon wafer, integrated circuit, as well as each bump on the integrated circuit; in most cases statistical sampling is used to monitor this process step and is considered a critical monitor for product reliability and yield.

Another market rapidly growing is the three-dimensional (3D) printer, or additive manufacturing market, in which 3D objects are either designed from scratch or are imaged in 3D and then reproduced. In the case of design from scratch, quality control of the 3D printed object can be monitored using geometric measurement tools to insure the appropriate manufacturing tolerance has been achieved. In the case of replication, a sufficiently accurate shell, or equivalent surface, can be measured and subsequently used to emulate the desired object, with the end user defining the internal matrix under constraints of weight, strength, and and/or function. These 3D print objects may be supplied to several industries including, but not limited to aerospace, bio-medical, or jewelry.

### Description of Prior Art

Much prior art exists for systems that use structured light for 3D scanning to extract geometrical measurements. Prior to the disclosed system, many structured light measuring system use a quasi-static projection of light (such as U.S. Pat. No. 6,064,759, U.S. Pat. No. 7,098,435, U.S. Pat. No. 7,625,335 and references therein, and U.S. Pat. No. 7,433,058) and analyze the subsequent captured images. A few of these approaches will analyze the bend or distortion in the line as a direct measure of displacement, as well as the width of the projected lines as a measure of surface curvature. In some cases, historical approaches will use a Fourier transform of the captured image to extract out the spatial frequencies of the measured surface to enable surface reconstruction. In most all cases, the historical systems use a multiple line widths and pitches in the structured light to remove phase errors. Many of these approaches could be considered static or unmodulated approaches and thus subject to higher background noise. Some of these approaches use shifting/moving light structure to enhance the signal but is typically limited to a linear shift in one dimension (such as U.S. Pat. No. 6,771,807, U.S. Pat. No. 7,079,666, and U.S. Pat. No. 4,742,237).

### SUMMARY OF INVENTION

The present invention provides a method and apparatus for generating and projecting structured light on a sample and subsequently measuring and analyzing the projected light to produce data in 3 dimensions. The structured light will consist of one or more lines of variable (controlled) width, pitch, and wavelength which will cover a predefined area and hence forward will be referred to as the Light Frame of Reference (LFOR). Within the LFOR there will be defined a central axis, about which the LFOR may be rotated. One or more sensors, which may include, but not be limited to, a CCD array or camera, measures the projected structured light on the sample at one or more locations and will be hence forward be referred to as the image capture data array (ICDA); images/data are captured as the LFOR is rotated thus generating an ICDA cube (ICDAC) of information. The data capture rate and the LFOR rotation rate are synchronized such that sufficient information is captured to satisfy Nyquist's Theorem for both spatial and temporal sampling.

A specified area, which may include but not be limited to a single pixel, in the ICDA is analyzed through the ICDAC which amounts to tracing the information in this predefined area as a function of time and thus light intensity modulation. A null condition exists in an area about the central axis, and can be removed by translating the LFOR, generating multiple LFOR's offset from one another, translating the sample, or other approaches. For a flat surface, the spatial frequencies will all be the same and therefore may be used, though not required to be used, as a reference signal for each trace through the ICDAC. A non-flat surface may contain multiple spatial frequencies, and thus will distort the structured light along the curvature of the surface; the amount of distortion is related to the displacement perpendicular to the incoming light. As the LFOR is rotated, the distortion manifests itself as a phase lag or lead in the ICDAC trace as compared to the reference flat surface. The relative phase compared to the reference for each trace in the ICDAC can be extracted through several methods including, but not limited to time differencing, Lissajous analysis, product methods, Fourier analysis, phase locking methods, etc. Each analysis will construct a phase difference which is unique within a 2π; elimination of 2π errors can be achieved through standard methods (common art) of changing the spatial frequencies contained in the LFOR and is considered known art.

Given the modulated nature of the apparatus, low level signals can be differentiated from back ground noise by using several different techniques, including time and frequency-based filtering, lock-in detections schemes, or other. Additionally, the wavelength of the light and the type of sensor can be adjusted to maximize not only the amount of reflected light but also the detector sensitivity to that wavelength of light.

### BRIEF DESCRIPTION OF THE DRAWINGS

FIG. 1 Basic layout consisting of a light source with the ability to project and rotate structured light consisting of one or more lines of various widths and pitch, a sensor capable of measuring the structured light, a second sensor which monitors the angular position of the structured light, and a computer system that is used to synchronize, gather and analyze data.

FIG. 2 Same system as above with light structure rotated to an arbitrary angle. The light structure can be rotated to arbitrary angles or be continuously rotated. The sensor can capture one or more images, or continually capture data.

FIG. 3 Simulation of signals used for phase measurements in which the method for generating relative phase uses reference images 8, 9 and sample images 10,11 to generate temporal comparisons at single pixels between the reference and sample images of two structured light lines 12, 13. Two specific cases are shown for the pixel comparison: in one case the structured light line is rotated about the center of the field of view 8,10, and in the other case, the structured light line is rotated about a displaced reference 9,11.

FIG. 4 Shows the relationship between the spatial period of the structured light (T), the measured phase delta (δ), and the height change (Δz).

FIG. 5 An alternative layout consisting of a light source with the ability to project and rotate structured light consisting of arrays of lines of various widths and pitch, sensors capable of measuring the structured light from the sample and reference simultaneously, one or more sensors to measure the angular position of the structured light, and a computer system that will be used to synchronize, gather and analyze data.

FIG. 6 One example of a two-step process used as part of one embodiment of the invention for generation and analysis of 3Dimensional data.

FIG. 7 An alternative single-step process used as part of one embodiment of the invention for generation and analysis of 3Dimensional data.

### DETAILED DESCRIPTION OF INVENTION

Reference is made herein to the attached drawings. Like reference numerals are used throughout the drawings to explain elements of the 3Dimensional measuring instrument. For the purpose of presenting a brief and clear description of the invention, the preferred embodiment will be discussed as used for the measurement of signal phase with subsequent analysis of this phase used to measure changes in distance. The figures are intended for representative purposes only and should not be considered to be limiting in any aspect.

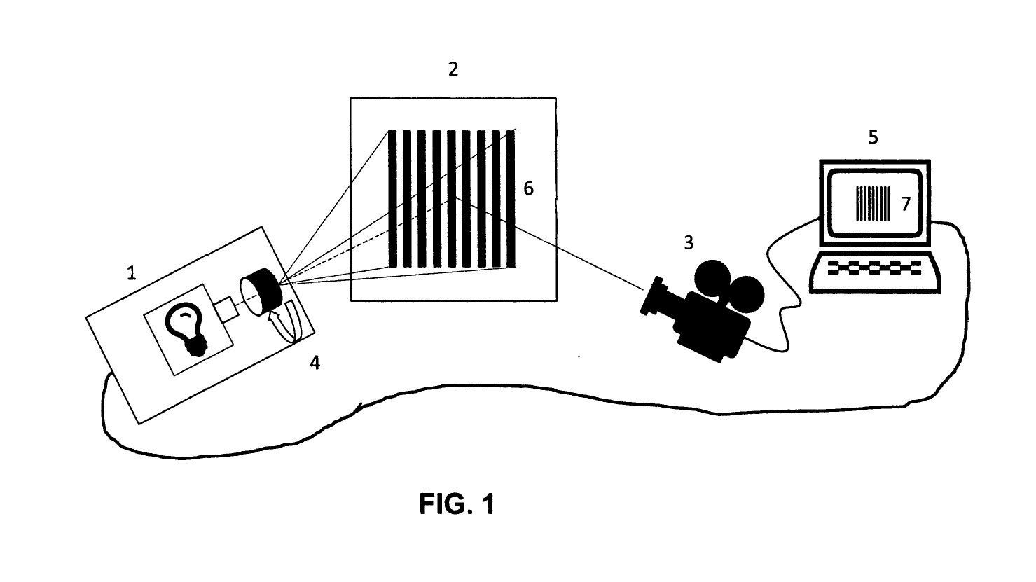

Referring to FIG. 1, a light source capable of generating rotating, structured light 1 is projected onto the sample area 2. The structured light 6, as projected onto the sample area 2, will be measured by a sensor 3. A separate sensor 4 will be used to measure the angular position of the structured light. The data from sensors 3 and 4 are collected and passed to a computing system 5. The computing system 5 will have the ability to synchronize the angular position as measured by sensor 4 with the data acquired by sensor 3. The computing system 5 will also store and analyze data.

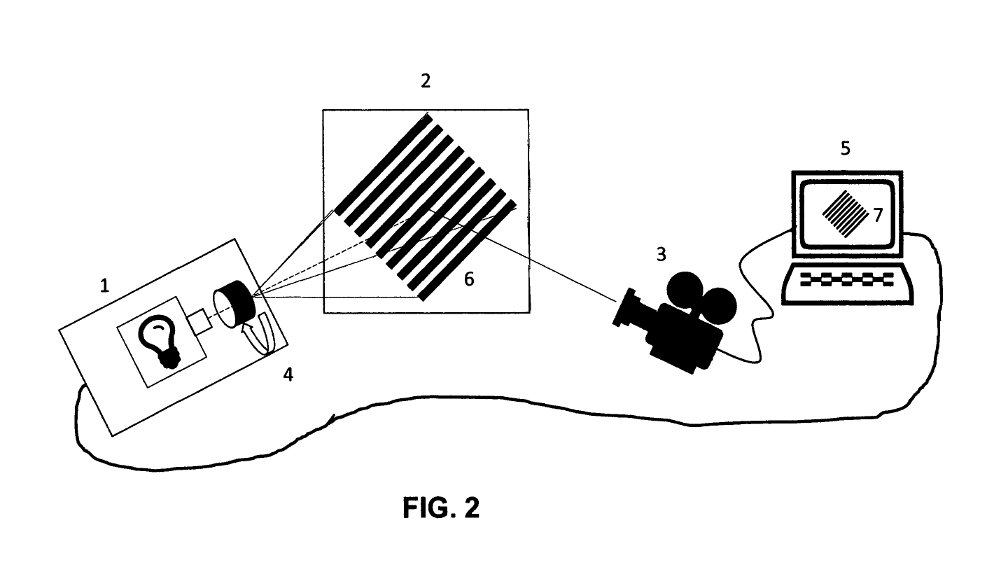

For clarity, FIG. 2 has the same layout as FIG. 1. However, in FIG. 2 the projected structured light 6 has been shown to be rotated to an arbitrary angle with its subsequent data representation 7 shown on the computer monitor. In application, the structured light can be rotated to arbitrary, discrete, angles or rotated continuously. In all cases, the data from the angle monitoring sensor 4 and the image monitoring sensor 3 will be synchronized as subsequently described.

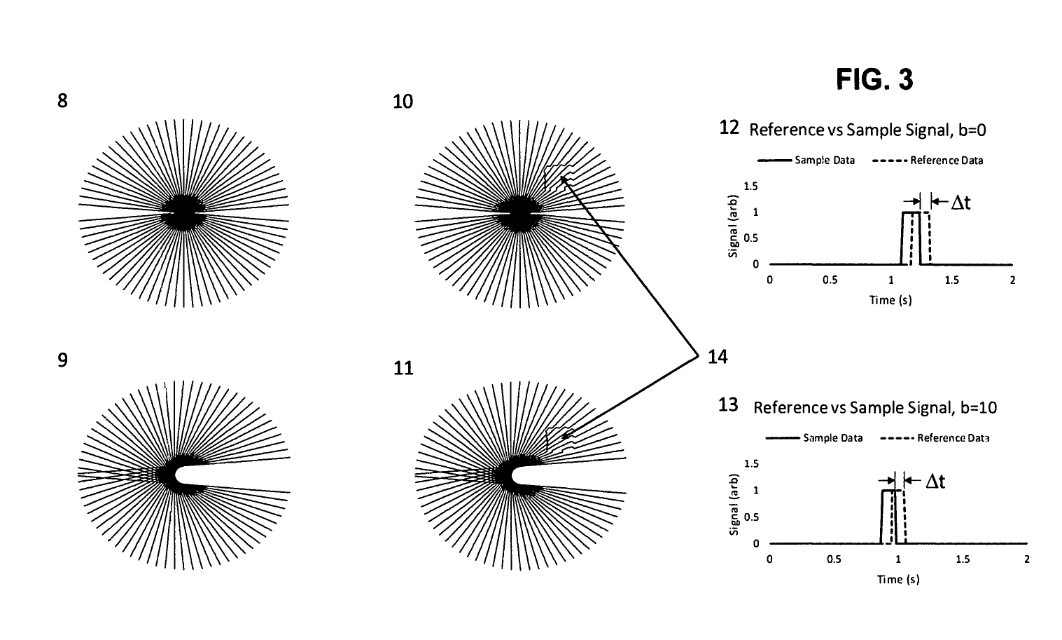

Referring to FIG. 3, simulation of signals of 2 line segments (y=mx+b, in arbitrary units) with (10,11) and without (8,9) a sample present, or sample and reference signals respectively. For simplicity, m is set to zero in both cases and line segments at b=0 and b=10 are compared (8,9 and 10,11 respectively). For simulation purposes, the line segments are rotated at a constant angular velocity (ω) of 0.1 rotations per second and images have been displayed at discrete angles from 5 degrees to 180 degrees in increments of 5 degrees. To demonstrate the signal response when a sample is present, a “box” 14 of arbitrary height has been inserted at the same locations shown in 10 and 11. A phase lead is shown for example purposes, indicating an “outward” forming box. Sensor signals are compared at the same location, with equivalent sensor size. In one implementation of the method, the phase delta (δ) can be calculated from a time analysis comparison of the reference signal to the sample signal shown in 12 and 13 simply by multiplying time offset between the signals (Δt) by ω.

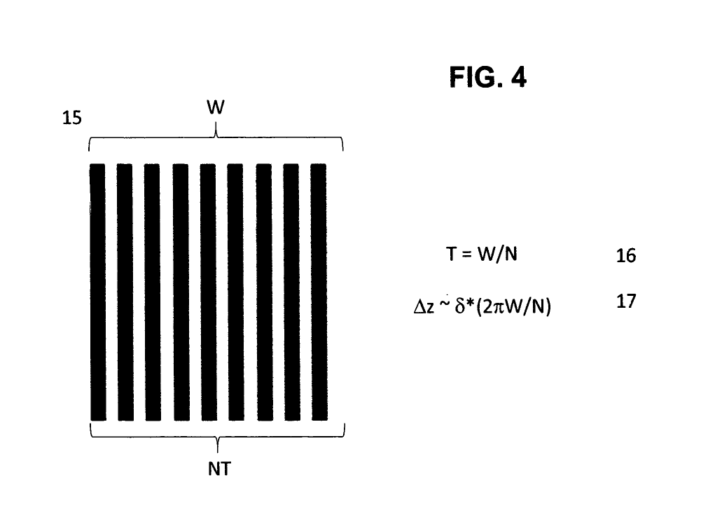

Referring to FIG. 4, one implementation of the method is described for using the spatial period (T) to relate the measured phase delta (δ) to the height change (Δz). The field of view 15 of known width W is composed of N periods of length T. Relating the known width of the structured light W to the number of periods (N*T) 16, the phase delta can be converted to distance using the approximation Δz^{˜}δ*(2πW/N) 17. Alternative calculation can be done in the sensor space using the resolution of the sensor, effective magnifications, and geometrical configuration of the optical system.

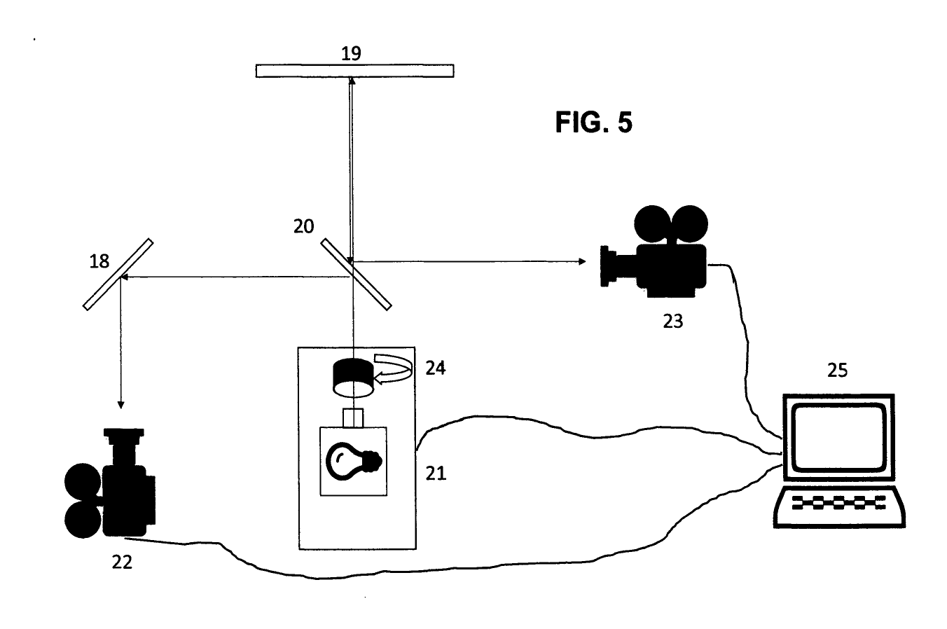

An alternative layout of the instrument is references in FIG. 5. In this one implementation, the reference 18 and the object 19 are measured simultaneously, or near simultaneously. For this implementation, an image splitting mirror 20 is used to direct the structured light generated form the light source 21 onto the reference 18 and object 19. Sensors 22 and 23 are used to measure the reflected structured light from the reference 18 and object 19 simultaneously, or near simultaneously. Sensors 24 is used to measure and track the angular position of the structured light. Computer and synchronizing hardware and software 25 are used to synchronize the data collection from sensors 22 and 23 with the position of the structured light as measured by sensor 24. Comparisons between data measured on the reference and sample subjects are done through computer algorithms and/or hardware comparators to calculate the relative phase.

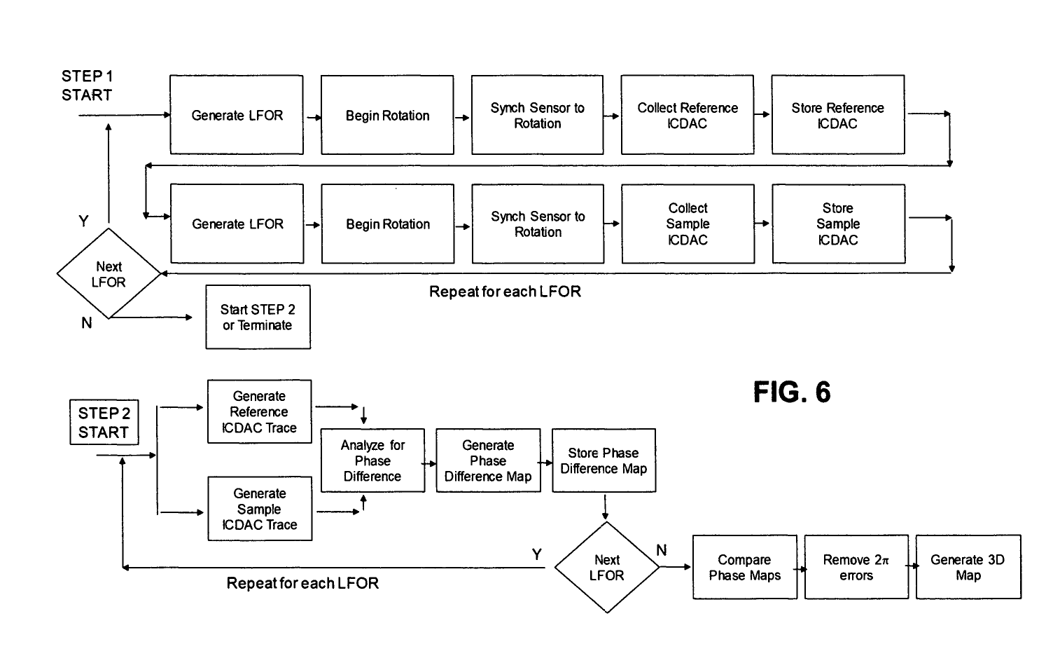

Referring to FIG. 6, an example two (2) step process for generation and analysis of data is described. In the Step 1, the structured light (Light Frame of Reference, LFOR) is generated at certain angles, rotated, and synchronized with the sensor; data (Image Capture Data Array Cube, ICDAC) is collected for both the reference and the sample for each LFOR and stored for processing in Step 2. This process can be repeated for multiple LFOR or terminated after a single comparison. In Step 2, ICDAC Traces (at each X,Y location in the sensor) are extracted from the stored IDAC for both reference and sample and analyzed to extract the relative phase; the relative phase is stored for each ICDAC trace to generate a phase map for each LFOR. Multiple Phase Maps are compared to identify any phase wrapping errors and the errors are corrected. Phase is converted to 3D height map information based upon the LFOR reference calibration. The 2 step process can be done sequentially or in parallel.

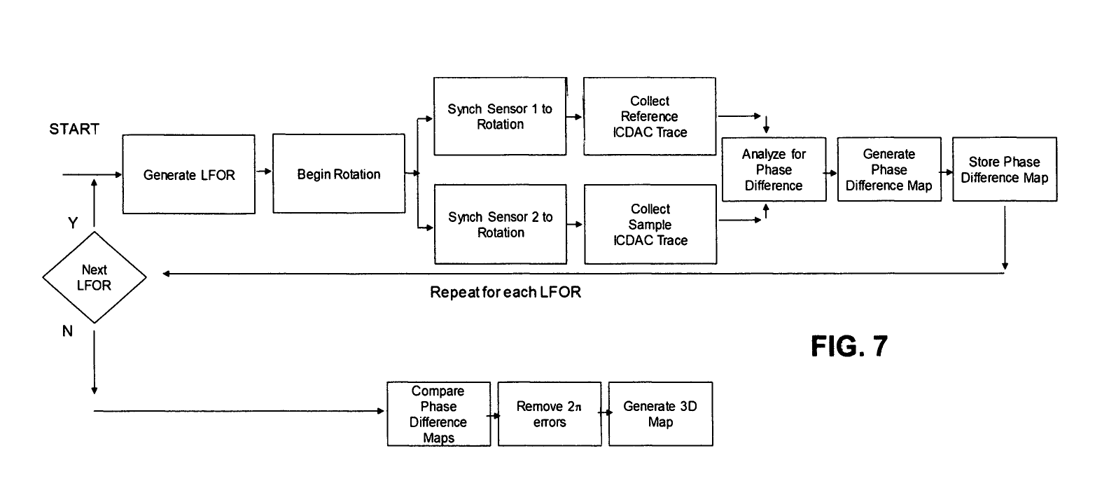

FIG. 7 shows a possible alternative single-step process for generation and analysis of data using the layout shown in FIG. 5. In this alternative approach, reference and sample data are collected and analyzed simultaneously. IDAC Trace analysis for relative phase may be done through software or through hardware.

I claim:

1) A method for reconstructing and/or measuring the surface of an object or objects using a combination of structured light and a periodic modulation; the said method comprising rotating the structured light around the center of the structured light reference frame, measuring the sensor signal from a reference surface and storing the signal of the reference surface for future use, measuring the signal in a sensor in each predefined areas of the object(s) and storing for future use, analyzing said signals using known methods to extract the phase difference between the reference and the object(s), and using said signal analysis in computing the relative surface height of the object.

2) A method for reconstructing and/or measuring the surface of an object or objects using a combination of structured light and a periodic modulation; the said method comprising rotating the structured light around the center of the structured light reference frame, creating a computer-generated, or synthetic, reference signal and storing the reference signal for future use, measuring a signal in the sensor in each predefined areas of the object(s) and storing for future use, analyzing the signals using known methods to extract the phase difference between the reference and the object(s), and using said signals in computing the relative surface height of the object.

3) A method for reconstructing and/or measuring the surface of an object or objects using a combination of structured light and a periodic modulation; the said method comprising rotating the structured light around the center of the structured light reference frame, measuring a signal from a reference surface and measuring a signal in the sensor in each predefined areas of the object(s) at the same, or nearly the same, time, comparing the signals utilizing an electronic comparator, analyzing the signals using known methods to extract the phase difference between the reference and the object(s), and computing the relative surface height of the object.

4) A method for reconstructing and/or measuring the surface of an object or objects using a combination of structured light and a periodic modulation; the said method comprising rotating the structured light around the center of the structured light reference frame, measuring a signal from a reference surface and measuring a signal in the sensor in each predefined areas of the object(s) at the same, or nearly the same, time, comparing to the signals utilizing an electronic comparator, analyzing the signals using known methods to extract the phase difference between the reference and the object(s) and computing the relative surface height of the object.

5) The method of claim 1, 2, 3, or 4 where the object is translated, or the structured light is translated, or multiple light sources are used to eliminate any null conditions.

6) The method of claim 1, 2, 3, or 4 where the object is translated, or the structured light is translated, or multiple light sources are used to eliminate any null conditions, and the method is repeated for different width and spatial frequency in the light source to extend dynamic range or eliminate phase errors.
